(19) United States
(12) Patent Application Publication
(10) Pub. No.: US 2007/0064992 A1
(43) Pub. Date: Mar. 22, 2007

(54) PROCESS FOR THE INSPECTION OF A VARIETY OF REPETITIVE STRUCTURES

(75) Inventors: Michael Teich, Moritzburg (DE); Juliane Busch, Dresden (DE); Axel Becker, Dresden (DE); Ralf Keller, Dresden (DE); Jorg Kiesewetter, Thiendorf (DE); Ulf Hackius, Dresden (DE)

Correspondence Address: Jeff Rothenberg, Esq., HESLIN ROTHENBERG FARLEY & MESITI, P.C., 5 Columbia Circle, Albany, NY, 12203, US

(73) Assignee: SUSS MICROTEC TEST SYSTEMS GMBH, Sacka (DE)

(21) Appl. No.: 11/470,884

(22) Filed: Sep. 7, 2006

(30) Foreign Application Priority Data
Sep. 16, 2005 (DE) 10 2005 044 502.0

(51) Int. Cl. G06K 9/00

(52) U.S. Cl. 382/141

(57) ABSTRACT

A process is provided for inspection of a variety of structures on the basis of a golden template, that was attained by recording and statistical analysis of greyscale pictures and is compared to the greyscale picture of the structure to be evaluated based on position. The underlying task is to report any such inspection process, with which a positioning of the test structure relative to the golden template and a structure detection with sub-pixel accuracy is carried out. In positioning of each further structure to be recorded, which follows a first recorded structure, the further structure is fundamentally positioned in accordance with the first positioned structure, applicable characteristic values of the greyscale picture recorded in this position are determined and hence a degree of similarity is determined. On this basis, the position of further structures relative to the primary position are determined and corrected with sub-pixel accuracy, before a new greyscale picture is recorded, which forms the basis for further analysis.

### BACKGROUND ART

The invention concerns a process for the inspection of a variety of repetitive structures, in which a reference picture (golden template) is first created, whereby a defined number of structures in succession, which fundamentally, correctly or acceptably, represent the structure aimed for, successively record greyscale pictures, values of applicable structure characteristics (characteristic values) are established and the averages of the characteristic values of all the greyscale pictures and/or the averages of the grey value of each pixel are calculated. Subsequently a greyscale picture of the structure to be evaluated (test structure) is recorded, the position of which is determined relative to the recording position of the golden template, the greyscale picture is compared to the golden template, taking into account its position and the result of the comparison is evaluated.

Such processes for determining errors and defects of structures are used in particular for mechanical inspection in the ongoing process of a large number of structures, such as it is necessary in various process stages of semiconductor technology. For this, an image of a structure, which corresponds to the target structure as far as possible, is compared to the test structures. Since, however, for the creation of this image only real, erroneous structures are available, it is necessary to create this image from a larger number of real structures using statistical methods. The result of averaging the various acceptable example pictures is known as the golden template.

The characteristic values, which are determined from the individual greyscale pictures, are always based on the geometry of the camera lens due to the necessary recording of the picture for their determination, so that an exact alignment of each structure used for the creation of the golden template relative to the lens and thus indirectly relative to the previous structure is necessary. The comparison of the test structure with the golden template likewise necessitates the same alignment, since a difference of position in the comparison would appear as a variation of the structure, so that the alignment of the structures to one another, real or virtual, is of particular importance in the golden template process.

The structure error detection can be carried out on the basis of the known picture recording and picture analysis system, at present with an accuracy up to 1/40 pixels. However, in the pixel range an error of ±½ pixel forms the basis of the alignment of the structure over the recording of geometric points. In order to achieve an accuracy of the alignment in the sub-pixel range, in a process which is specified in U.S. Pat. No. 5,850,466, a digital sub-pixel adjustment is carried out. This is based on a statistical analysis of the positioning variations recorded and saved for the creation of the golden template. For this purpose a large number of greyscale pictures of acceptable structures with divergent, defined positions are saved. These are assigned to an index, which reproduces the grid-like division of the area of a pixel point. Furthermore, for noise suppression the accumulation of a defined number of greyscale pictures in each indexed position or at least a subset thereof with subsequent transformation into the residual positions is necessary, so that in actual fact for each indexed position a golden template must be saved.

For the analysis of a test structure, a classification of the recorded greyscale picture to be evaluated is conducted with one of the saved, reproduced golden template pictures, whose sub-pixel position corresponds to the pixel resolution, is carried out prior to the comparison of the golden template with respect to the mould error. This sub-pixel adjustment improves the accuracy to approximately ±⅛ pixel but necessitates, depending on the desired accuracy and on the template size, a very large memory, which increases further with decreasing scaling of the components and reduced pixel size.

A possibility to reduce the memory requirements is specified in U.S. Pat. No. 5,850,466 as digital resampling. Here the recorded picture is digitally displaced during the inspection until a maximum compliance with the golden template is achieved. This is carried out by interpolation from known surrounding positions. Therefore it is necessary, that for a minimum number of positions the structure picture must be known. If, however, this is already erroneous, this error increases as a result of the interpolation and leads to a falsified evaluation of the structure.

### BRIEF SUMMARY OF THE INVENTION

The invention is therefore based on the assignment, to report any such inspection process, with which a positioning of the test structure relative to the golden template and a structure detection with sub-pixel accuracy is carried out and the specified disadvantages are avoided.

This assignment is resolved through a process, in which for positioning each further structure to be recorded, which follows a first recorded structure (primary position), the further structure fundamentally corresponds to the first positioned and a further greyscale picture of the further structure is recorded, the characteristic values of the further greyscale picture determined, with which the greyscale picture of the first structure (primary picture) is compared and a degree of similarity is determined, the position of the further structure relative to the primary position is determined and is accordingly corrected with sub-pixel accuracy, in so far as the degree of similarity lies within a predefined tolerance range, and subsequently a further corrected greyscale picture is recorded, which forms the basis for further analysis.

With this process the detection of structure errors in the sub-pixel range is also combined with the real positioning of the structure in the sub-pixel range. Thus the analysis of the greyscale pictures is based on quasi-stable recordings of the structures and the variations, which are recorded by the apparatus, are reproduced for each recording, whereby their influence on the comparison of the structures is fundamentally reduced. The real positioning in the sub-pixel range causes a fundamental decrease of this geometrically contingent noise, which occurs alongside the filter effect for the temporal noise as a result of the statistical analysis. The causes of the geometric noise lie for example in variations of the lighting, which ideally should be even over the area of the structure, as well as variations of the lens or the camera target or also variations in the electronics or the digitalisation.

By applying this repositioning in the sub-pixel range to each further structure recorded after the first structure, the stated advantages are not only used for structure error detection in the ongoing inspection, but are also already used for the creation of the golden template itself. Thus, the innovative solution fundamentally contributes to creating any such image as a reference picture, that comes very close to the structure aimed for.

The first structure is always of particular importance on account of the recording of a variety of real structures, which are compared to the saved structure for the creation of the golden template, so that by appropriate choice of a correct or at least almost correct structure or also by numerical creation of the image of an ideal structure, the basis for determining the degree of similarity and repositioning is set.

The characteristic values which are used for the creation of the golden template and the determination of the degree of similarity, are dependent on several factors, in particular on the type of structure and the accuracy necessary for that structure. In particular, the determination of the geometric characteristics of the contours, such as angles, arches, form and dimensions of an area, its focal point, its diameter or its shadings proves to be particularly advantageous. Thus it can be determined by means of shadings and swells, whether a rise or a cavity is recorded. Furthermore the use of geometric characteristics allows, using the appropriate software, the identification and position determination of structures, even if these are only visible in sections, rotated or scaled. For this, the spatial relationships, including angles and distance, of the appropriate geometric characteristics of the golden template are adjusted to those of the real-time image and thus the actual position of the recorded structure is determined.

An alternative possibility is the analysis of the values of the greyscales of the respective pixel matrix of a structure, if such variations or overlaps do not occur. With this localisation based on so-called correlation, the greyscales of the golden template are compared to the real-time picture and the X/Y position is determined, with which the golden template best corresponds to the picture, and from this, the position of the structure is determined. In this version of the process, the golden template is only defined by the average of the grey values of each individual pixel, in which an additional geometric inspection is fundamentally possible.

In accordance with a particularly advantageous version, the repositioning is carried out with a cross table. Using both the guidance directions, which generate an angle with great accuracy, of 90° in particular, a reproducible positioning is possible, at present with an accuracy of up to 1/15 pixel.

For the determination of the degree of similarity, which forms the basis of the repositioning, the positions of the further structures to be recorded after the first structure must be sufficiently exact, for a similarity based on the lens coverage of the camera to be determined. For this it is beneficial, if the positions of the further structures are determined and adjusted, by positioning each further structure according to a standardised rule of movement on the basis of the position of the first structure (primary position). This can take place subject to the type of structure, for example by mechanical positioning of the individual structures with an adjustable or saveable movement procedure, or by arranging the structures on a support.

In particular such structures, which are arranged in fixed positions to each other in a grid, are positioned corresponding to a version of the invention, by displacing each structure in succession, starting from the primary position at steps which correspond to the grid dimension. With the known grid dimension, which as a rule is divisible in the X and Y direction, a quick first positioning is possible, with such accuracy that a good similarity can already be produced. This is the case in particular, if the steps are also taken with a cross table. In doing so it is beneficial, if the movement limits for the positioning are defined by determining a maximum number of steps.

In the case of positioning such structures arranged in grids, a distinct reduction of the time necessary for the positioning is achieved, in so far as with the positioning of the first structure, an angle alignment between the grid and a preferred movement direction for the positioning of the structures is carried out. After the single angle alignment has been performed, for example to one of the movement directions of the cross table, just one more alignment is carried out following each step, in the directions in which the structure was moved.

Further beneficial versions of the process in accordance with the invention specify that the grey value of a pixel is set at a predefined higher or lower grey value, in so far as it exceeds or falls below a predefined limit value. With this additional process step a filter is implemented, which improves the contrast of the picture, by setting the transitions, contaminations or similar structure blurring or disturbing components, by a favourable dimension in white direction, which represents the highest grey value, or alternatively in black direction. Therewith, the edges can be reinforced, the contours of the individual components of a structure improved or the disturbing contrast of the surface areas counterbalanced, so that the geometric analysis, for example using area, centre of area and diameter, can be specified more precisely. The change of pixel values to lower grey values is particularly advantageous with opaque structures, for example structures applied to silicon.

With the process in accordance with the invention, fundamentally three as well as two dimensional structures can be examined, as from them two dimensional pictures are always created. In particular with detailed structures or those, whose two dimensional image does not adequately reproduce the evaluable structure, it is beneficial first of all to adapt the recorded data, so that the comparison is possible and reproducible. Thus, with three dimensional structures, for example, transitions between different planes in the two dimensional image can be reinforced. A negation of the recording or an extension of the picture content of all similarly used recordings can also be useful or necessary.

For the creation of the golden template, it is necessary to record a statistically analysable number of correct structures or at least a number of such structures that lie within the acceptable limits, so that their errors via the averaging become negligible. This would sometimes necessitate a high outlay for this structure choice. Therefore a version form is beneficial, in which a preliminary template is determined for the creation of the golden template, from the greyscale pictures already recorded, with which each following greyscale picture of the predefined number of structures is compared and from a predefined correlation, whose characteristic values and/or grey values by pixel are averaged with those of the previous preliminary template for the creation of a new preliminary template.

In this way it is also possible to use the process in accordance with the invention for the required choice of “good” structures. Only the first structure must be chosen and evaluated with conventional methods, applicable to individual structures or an appropriate image must be created. In particular for grid-like arranged structures, a continuous inspection by gradual shutdown of the raster can be implemented therewith and at the same time the golden template can be generated.

For the comparison of the test structure to the golden template, it is beneficial if a negative template is created from the golden template and the grey values of the test structure are added to the grey values of the negative template by pixels. Therewith, after an absolute accumulation of values, a positive picture from the result of the addition is received, from which as a result of the negation of the grey values of the golden template the errors with higher grey values, that is lighter than black, are immediately apparent. Therefore, it is also fundamentally possible to create a negative from the pictures of the test structure instead of from the picture of the golden template.

Since not every error of a structure leads to its rejection, it makes sense if the structure and/or an interrelated unit of structures is classified according to errors, in order to determine, for example, the type of subsequent processing or subsequent use. Precisely with an interrelated unit of structures, for example with templates or bump arrays of the individual dies in the wafer network, with which “good” and “bad” structures always exist within the unit, the limitation is carried out from which type and which area of the errors the total unit is to be discarded, is to be corrected or is useable. A sampling inspection agreed on the basis of quality management can be conducted for the evaluation of the structure unit.

### DETAILED DESCRIPTION

The invention is to be illustrated in more detail in the following with a version example, in which the structures of solder bump arrays are examined. The solder bump arrays in this example are arranged grid-like on a matrix made out of glass (mould) with a grid dimension in X direction and Y direction, in order to transfer them in a later process from this mould to operational dies in the wafer network.

A mould is chosen by manual inspection, that shows a predefined minimum number of correct or at least acceptable array structures of the individual dies. This mould aids the generation of the golden template, an image of the structure, which should represent the basis for the later inspection. In the described version example a minimum number of approximately 10% of the total number of array structures on the mould are proved as adequate for the generation of an appropriate golden template. Initially the mould is set on an X Y cross table in such a way that an axis of the grid corresponds to a movement direction of the cross table. Subsequently, the greyscale picture of the structure of a solder bump array of the mould is recorded as the primary picture. The pixel number of the camera chip in the described version example is 1620×1220 pixels, with an image resolution of 15 μm/pixel and a bump diameter of 9 to 10 pixels. From this greyscale picture, geometric characteristics of the individual bumps, such as area, diameter and centre of area are determined and saved, using geometric-orientated image processing software.

Subsequently the breaking-in of the structure is carried out on the basis of the primary picture. For this purpose the position of the primary picture is defined as the primary position and the size of the steps in X and Y direction are determined, with which the cross table automatically encounters the individual solder bump arrays of the moulds and these are fundamentally consistently positioned, each based on the camera position and relative to the previous solder bump array. A step thereby corresponds to the ideal distance of an appropriate known point of one solder bump array to the same known point of its adjacent solder bump array. By input of the number of steps, the number of recordings is defined, which should be used for the generation of the golden template.

After the first step has been taken, a greyscale picture of the next solder bump array is recorded. The above-mentioned geometric characteristics of this greyscale picture are also determined. Using the image-processing software, these are compared to the geometric characteristics of the primary picture and from the comparison a difference of position of the actual structure in comparison to the primary position, as well as of the degree of similarity of the two greyscale pictures, is determined.

If the degree of similarity resides within a predetermined tolerance limit, the structure is repositioned, so that the difference of position is counterbalanced. If however the degree of similarity exceeds the tolerance limit, the picture of this solder bump array is discarded, the next is started, recorded and repositioned. Subsequently a new greyscale picture of this solder bump array is recorded. From this greyscale picture and the primary picture, the average values of the grey values of each pixel are generated and saved as a preliminary golden template.

In this way, step for step in succession, the chosen solder bump arrays are approached in accordance with the defined step sequence, greyscale pictures of each individual solder bump array are recorded and, subject to the determined degree of similarity, are averaged with the respective previous greyscale picture, for the creation of a new preliminary golden template. As a result, the golden template of the structure of the solder bump array is created, in the form of the average values of the grey values of each pixel of the greyscale picture of the solder bump array. From the determined greyscale picture of the golden template, a negative greyscale picture is numerically created and saved. The geometric characteristics of the averaged greyscale picture are determined and likewise saved.

For the evaluation of the solder bump arrays of each mould to be tested (test array), in the same way, according to the angle alignment of the mould and by the input of x-fold steps in succession, for a sampling inspection, test arrays of the moulds chosen at random are approached, recorded, chosen by means of their geometric characteristics, repositioned and a new greyscale picture is recorded.

For the comparison of this greyscale picture to the golden template, the grey values are added to the grey values of the negative of the golden template by pixel, so that as a result a picture of the errors of the test array is created. The geometric characteristics of these errors are also determined and on this basis a classification of the type of error and of the error extent of each test array as well as of the total mould is conducted. For example the size of a grey area of the picture, the picture centre and its distance to the next area centre are determined, in order to determine a bump that is too big, a bump bridge, a missing bump, a systematic error in the assignment of the solder measure or contamination of the mould and hence to reach a conclusion about the usability of the entire mould.

The described inspection is applicable to both the solder bump array of the mould and to the empty mould, which shows the array structure in the form of dips recording solder bumps. The dips are represented in the greyscale picture by rings, in which the edges of the valleys are reinforced by an appropriate filter, for example a polarisation filter, and the rings can be digitally filled for an analysis, which corresponds to those dips filled with solder bumps.

1. A process for inspection of a variety of repetitive structures, in which a reference picture or golden template is first created, wherein a defined number of structures in succession, which fundamentally, correctly or acceptably, represent a structure aimed for, are successively recorded as greyscale pictures, characteristic values of applicable structure characteristics are established and averages of the characteristic values of all the greyscale pictures and/or averages of the grey value of each pixel are calculated; subsequently a further greyscale picture of a test structure to be evaluated is recorded, the position of the test structure is determined relative to the recording position of the golden template, the further greyscale picture is compared to the golden template, taking into account the position of the test structure and the result of the comparison is evaluated, wherein
for positioning of each further structure to be recorded, which follows primary positioning of a first recorded structure, the further structure fundamentally corresponds to the first positioned structure and from the further structure a further greyscale picture is recorded,
the characteristic values of the further greyscale picture are determined, with which a greyscale picture of the first structure is compared and a degree of similarity is determined
the position of the further structure relative to the primary position is determined and is accordingly corrected with sub-pixel accuracy, in so far as the degree of similarity lies within a predefined tolerance range, and
then a further corrected greyscale picture is recorded, which forms a basis for further analysis.

2. The process for the inspection of a variety of repetitive structures in accordance with claim 1, wherein as characteristic values of the structures, geometric values are determined and the relative position determination and/or the determination of the degree of similarity is carried out on the basis of these geometric values.

3. The process for the inspection of a variety of repetitive structures in accordance with claim 1, wherein as characteristic values of the structures, values of greyscales of respective pixel matrices are analysed and the relative position determination and/or the determination of the degree of similarity is carried out on the basis of these greyscale values.

4. The process for the inspection of a variety of repetitive structures in accordance with claim 1, wherein repositioning is carried out with a cross table.

5. The process for the inspection of a variety of repetitive structures in accordance with claim 1, wherein the fundamental positioning of each further structure is carried out, starting from the primary position of the first structure, by positioning each further structure according to a standardised rule of movement.

6. The process for the inspection of a variety of repetitive structures in accordance with claim 1, wherein structures, which are arranged in fixed positions to each other in a grid, are positioned, by displacing the grid by steps which correspond to a grid dimension starting from a primary position of the grid.

7. The process for the inspection of a variety of repetitive structures in accordance with claim 6, wherein movement limits for the positioning are defined by determining a maximum number of steps.

8. The process for the inspection of a variety of repetitive structures in accordance with claim 6, wherein with the positioning of the first structure, an angle alignment between the grid and a preferred movement direction for the positioning of the structures is carried out.

9. The process for the inspection of a variety of repetitive structures in accordance with claim 1, wherein a first grey value of a pixel is set at a predefined higher grey value, in so far as the first grey value exceeds a predefined limit value.

10. The process for the inspection of a variety of repetitive structures in accordance with claim 1, wherein a first grey value of a pixel is set at a predefined lower grey value, in so far as the first grey value falls below a predefined limit value.

11. The process for the inspection of a variety of repetitive structures in accordance with claim 1, wherein for creation of the golden template from the greyscale pictures already recorded, a preliminary template is determined, with which each following greyscale picture of the predefined number of structures is compared and from a predefined correlation, whose characteristic values and/or grey values by pixel are averaged with those of the previous preliminary template for the creation of a new preliminary template, in such a way that each picture included in the averaging is incorporated at the same ratio.

12. The process for the inspection of a variety of repetitive structures in accordance with claim 1, wherein for the comparison a negative template is created from the golden template and the grey values of the test structure are added to the grey values of the negative template by pixel.

13. The process for the inspection of a variety of repetitive structures in accordance with claim 1, wherein for the comparison a negative template is created from the greyscale picture of the test structure, whose grey values are added to the grey values of the golden template by pixels.

14. The process for the inspection of a variety of repetitive structures in accordance with claim 1, wherein the structures and/or an interrelated unit of structures is classified according to errors.
